(19) United States
(12) Patent Application Publication
(10) Pub. No.: US 2026/0084655 A1
(43) Pub. Date: Mar. 26, 2026

(54) SYSTEMS AND METHODS TO DEFOG A VEHICLE GLASS SURFACE

(71) Applicant: Ford Global Technologies, LLC, Dearborn, MI (US)

(72) Inventors: Mahmoud Yousef Ghannam, Canton, MI (US); Robert Schroeter, Livonia, MI (US); Justin Miller, Berkley, MI (US); Brezalel Leviston, Spring, TX (US)

(73) Assignee: Ford Global Technologies, LLC, Dearborn, MI (US)

(21) Appl. No.: 18/891,186

(22) Filed: Sep. 20, 2024

(51) Int. Cl. B60S 1/54

(52) U.S. Cl. CPC B60S 1/54

(57) ABSTRACT

A vehicle including a front windshield, a sensor, a camera, an HVAC unit and a processor is disclosed. The sensor is configured to detect a humidity level at the front windshield, and the camera is configured to capture an image of a target vehicle glass surface. The processor is configured to determine that the humidity level is greater than a predefined threshold based on inputs obtained from the sensor. The processor further obtains the image from the camera responsive to determining that the humidity level is greater than the predefined threshold, and detects a presence of fogging on the target vehicle glass surface based on the image. The processor additionally determines a fogging level on the target vehicle glass surface based on the image, and controls an HVAC unit operation based on the fogging level to defog the target vehicle glass surface

### FIELD

The present disclosure relates to systems and methods to defog a vehicle glass surface based on images captured by a vehicle camera and optimal control of vehicle's heating, ventilation, and air conditioning (HVAC) unit.

### BACKGROUND

It is known that fogging occurs on a glass surface when warm, moist air comes in contact with the glass surface at cold temperature. When fogging occurs on a front windshield of a vehicle, a vehicle operator or driver may actuate the vehicle defrost system.

Many modern vehicles have mechanisms that automatically detect fogging on the front windshield and perform mitigation actions to defog the front windshield. While the conventional mechanisms are effective in defogging the front windshield, the conventional mechanisms are not equipped to detect fogging at other glass surfaces of the vehicle, e.g., side windows, the vehicle's top portion window, the rear windshield, interior and exterior mirrors, and/or the like. There may be instances where the vehicle operator may desire to defog other vehicle glass surfaces as well, in addition to the front windshield.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a first interior view of an example vehicle in accordance with the present disclosure.

FIG. 2 depicts a block diagram of a system to defog one or more vehicle glass surfaces in accordance with the present disclosure.

FIG. 3 depicts a second interior view of an example vehicle in accordance with the present disclosure.

FIG. 4 depicts a table illustrating example mitigation actions that may be performed to defog one or more vehicle glass surfaces in accordance with the present disclosure.

FIG. 5 depicts a flow diagram of an example method to defog one or more vehicle glass surfaces in accordance with the present disclosure.

### DETAILED DESCRIPTION

### Overview

The present disclosure describes a vehicle that may be configured to detect a presence of fogging at one or more vehicle glass surfaces (which may be different from a vehicle front windshield), and perform remedial actions to defog the affected vehicle glass surfaces. Examples of such vehicle glass surfaces include, but are not limited to, side windows, a rear windshield, mirrors, built-in displays, etc. The remedial action may include, for example, causing a vehicle's heating, ventilation, and air conditioning (HVAC) unit to blow air towards the affected vehicle glass surfaces (and not towards other vehicle glass surfaces that may not be fogged) to defog the affected surfaces.

The vehicle may include a humidity sensor configured to detect a humidity level at the front windshield. The vehicle may use the inputs obtained from the humidity sensor to determine if the humidity level at the front windshield may be greater than a threshold value. Responsive to determining that the humidity level may be greater than the threshold value, the vehicle may obtain an image of a target vehicle glass surface (“target vehicle glass surface image”) from a vehicle camera. In some aspects, the target vehicle glass surface may be that vehicle glass surface on which a probability of fogging may be high. For example, the target vehicle glass surface may be that vehicle glass surface in proximity to which a user may be sitting or a hot beverage/wet shoes/cloth, etc. may be present.

Responsive to obtaining the target vehicle glass surface image, the vehicle may compare the target vehicle glass surface image with a pre-stored image of the target vehicle glass surface at no-fog condition (i.e., when the target vehicle glass surface may be clean). Based on the comparison, the vehicle may determine whether fogging is present on the target vehicle glass surface or not.

Responsive to determining the presence of fogging at the target vehicle glass surface, the vehicle may correlate the target vehicle glass surface image with a training data including a plurality of pre-stored images of the target vehicle glass surface at different fogging levels. Based on the correlation, the vehicle may determine the fogging level at the target vehicle glass surface (e.g., whether the fogging level is high, medium, low, etc.).

The vehicle may then cause the HVAC unit to blow air towards the target vehicle glass surface to defog the target vehicle glass surface, based on the determined fogging level. For example, the vehicle may set the HVAC unit fan speed as high, medium, low, etc. based on the fogging level at the target vehicle glass surface. The vehicle may further control/adjust a time duration for which the HVAC unit may blow air towards the target vehicle glass surface based on the fogging level. The vehicle may additionally control the HVAC unit operation (e.g., the fan speed and/or the time duration) based on a location and/or a type of the target vehicle glass surface.

The present disclosure discloses a vehicle that efficiently detects fogging at vehicle glass surfaces different from the front windshield, and performs remedial actions to defog the affected surfaces. The vehicle utilizes existing cameras, sensors and units to detect the fogging and perform remedial actions, and hence does not require any external units/components to perform the operations disclosed in the present disclosure. Further, the vehicle causes the HVAC unit to blow air towards only those vehicle glass surfaces that are affected by fogging and not towards other glass surfaces, thereby ensuring that the vehicle's resources/energy required to operate the HVAC unit are optimally utilized. Furthermore, the vehicle controls/adjusts the HVAC unit fan speed and/or the time duration of operation based on the fogging level, so that the HVAC unit does not unnecessarily consume energy for operation.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

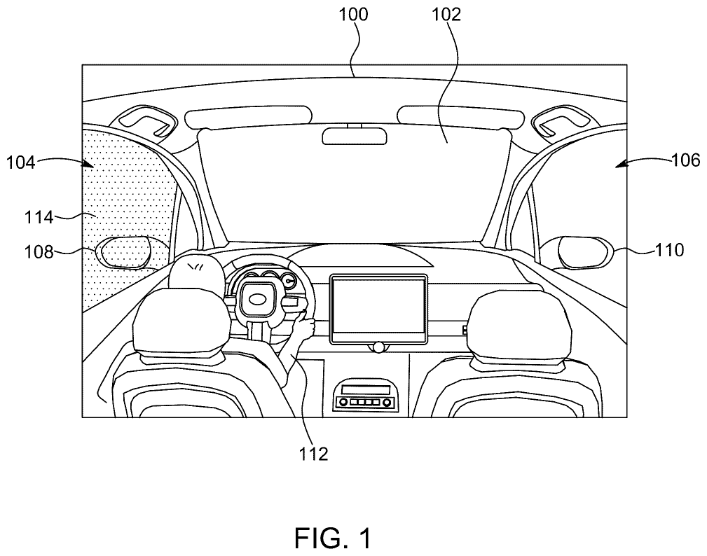

FIG. 1 depicts a first interior view of an example vehicle 100 in accordance with the present disclosure. The first interior view is a view of a vehicle interior portion. The vehicle 100 may take the form of any passenger or commercial vehicle such as a car, a work vehicle, a crossover vehicle, a truck, a van, a minivan, a taxi, a bus, etc. The vehicle 100 may be a manually driven vehicle or may be configured to operate in a partially/fully autonomous mode. Further, the vehicle 100 may include any powertrain such as a gasoline engine, one or more electrically-actuated motor(s), a hybrid system, etc.

The vehicle 100 may include a plurality of components including, but not limited to, a front windshield 102, a left side window 104, a right side window 106, a left rearview mirror 108, a right rearview mirror 110, a vehicle's top portion window (not shown), one or more built-in displays (not shown), and/or the like. Furthermore, a driver/user 112 may be sitting at a vehicle's driver sitting area. Although FIG. 1 depicts a single user 112 sitting in the vehicle 100, the present disclosure is not limited to the illustration shown in FIG. 1. Multiple users may be sitting in the vehicle interior portion (e.g., at a passenger sitting area and/or rear sitting areas), without departing from the present disclosure scope.

It is known that condensation forms on a cold surface when warm, moist air comes in contact with the cold surface. For example, condensation may form on the interior surface/portion of the vehicle's glass surfaces described above (e.g., the left side window 104, the right side window 106, the left rearview mirror 108, the right rearview mirror 110, and/or the like) when warm, moist air present in the vehicle interior portion comes in contact with the glass surfaces, and the glass surface temperature is low (e.g., during winter season). The air in the vehicle interior portion may be warm and moist due to different reasons, e.g., due to breath of the user 112 (or other users present in the vehicle interior portion), presence of warm beverages, wet clothes, shoes, etc., lack of fresh air circulation, and/or the like. The moisture due to the condensation typically appears on the glass surface as tiny water droplets, creating a blurry fog or causing “fogging” on the glass surface. An example view of a fogged area 114 on an interior left side window portion/surface (that faces the vehicle interior portion) is shown in FIG. 1.

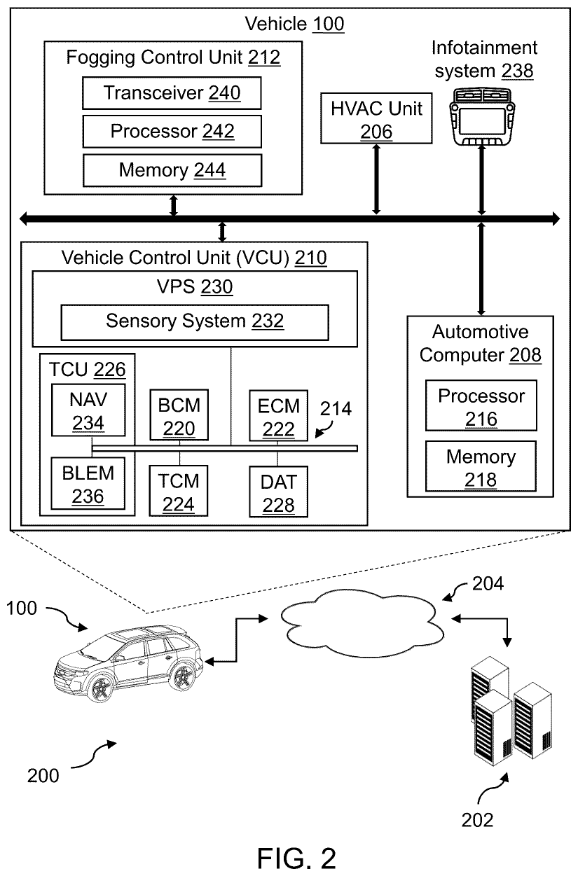

In some aspects, the vehicle 100 may further include a humidity sensor (that may be part of a vehicle sensory system 232, shown in FIG. 2) that may be part of or installed in proximity to the front windshield 102. The humidity sensor may be configured to detect a humidity level on the front windshield 102. The vehicle 100 may be configured to detect a presence of fogging on the front windshield 102 based on inputs obtained from the humidity sensor (and also inputs obtained from one or more vehicle temperature sensors), and perform a remedial action to defog (or remove/reduce the fogging on) the front windshield 102. In an exemplary aspect, the remedial action may include causing a vehicle's heating, ventilation, and air conditioning (HVAC) unit (shown as HVAC unit 206 in FIG. 2) to blow air towards the interior portion/surface of the front windshield 102, thereby causing the front windshield 102 to defog or the condensation to remove.

The humidity sensor described above may not be configured to detect humidity levels at other vehicle glass surfaces (e.g., the left side window 104, the right side window 106, the left rearview mirror 108, the right rearview mirror 110, and/or the like). To ensure that the vehicle 100 optimally detects fogging at other vehicle glass surfaces (that are different from the front windshield 102), the vehicle 100 may obtain images of one or more vehicle glass surfaces from one or more vehicle cameras (that may be part of the vehicle sensory system). Responsive to obtaining the images, the vehicle 100 may analyze the images and detect the presence of fogging on one or more vehicle glass surfaces based on the image analysis. The process of detecting the fogging based on the image analysis is briefly described below, and described in detail in conjunction with FIG. 2.

Hereinafter, the term “vehicle glass surface” means the left side window 104, the right side window 106, the left rearview mirror 108, the right rearview mirror 110, the vehicle's top portion window (not shown), the built-in displays (not shown), and/or the like, which are different from the front windshield 102. Stated another way, hereinafter, the term “vehicle glass surface” does not refer to the front windshield 102, but instead refers to other vehicle's glass surfaces that are different from the front windshield 102.

The vehicle 100 may pre-store (e.g., in a vehicle memory, shown as memory 244 in FIG. 2) images (or “first images”) of each vehicle glass surface in a “no-fog” condition. Specifically, the first images may be those images of the vehicle's glass surfaces when the glass surfaces may not be fogged or may be clean. In some aspects, the vehicle 100 may pre-store the first images for each vehicle glass surface at different ambient conditions/light intensities, e.g., during night time, during day time, at different ambient light intensity levels, etc.

The vehicle 100 may further pre-store a plurality of second images associated with each vehicle glass surface at different levels of fogging (or “fogging levels”). The fogging levels may be defined by a vehicle manufacturer or a vehicle operator, In an exemplary aspect, a fogging level “0” may denote no fogging at the vehicle glass surface (i.e., denote that the vehicle glass surface is clean), a fogging level “1” may denote a blurry surface, a fogging level “2” may denote a surface with condensation, a fogging level “3” may denote a surface with streaks of drops, and/or the like. The example fogging levels described herein should not be construed as limiting, and the fogging levels may be defined in any other manner without departing from the present disclosure scope.

In some aspects, to detect a presence of fogging on a vehicle glass surface (e.g., the left side window 104), the vehicle 100 may compare an image of the left side window 104 captured by the vehicle camera(s) (or a captured “left side window image”) with the associated first image of the left side window 104 (i.e., an image of the left side window 104 with no fogging). The vehicle 100 may detect the presence of fogging on the left side window 104 when the captured left side window image is different from the first image associated with the left side window 104.

Responsive to detecting the presence of fogging on the left side window 104, the vehicle 100 may correlate the captured left side window image with the plurality of second images associate with the left side window 104, to determine a fogging level on the left side window 104. Based on the determined fogging level, the vehicle 100 may then perform one or more remedial actions to defog the left side window 104. For example, the vehicle 100 may cause the vehicle's HVAC unit to blow air towards the left side window 104 to defog the left side window 104. The vehicle 100 may further adjust the rate of airflow towards the left side window 104 (e.g., adjust the HVAC unit's fan speed) and/or a time duration for which the HVAC unit blows air towards the left side window 104 based on the determined fogging level.

In this manner, even though the left side window 104 (or any other vehicle glass surface) does not have an associated humidity sensor, the vehicle 100 is still able to effectively detect the presence of fogging on the left side window 104 based on image analysis, and optimally defog the left side window 104. Further, the vehicle 100 ensures that the HVAC unit blows air only towards the vehicle glass surface that is fogged (i.e., the “affected” vehicle glass surface, e.g., the left side window 104), and not towards other vehicle glass surfaces that may be unaffected by fogging, thereby ensuring that unnecessary energy is not consumed in operating the HVAC unit. Furthermore, the vehicle 100 may monitor the fogging level on the affected vehicle glass surface over time and may adjust the HVAC unit operation (e.g., the fan speed and/or the time duration of HVAC unit operation) based on the “real-time” fogging level, thereby further ensuring that the HVAC unit is not unnecessarily utilized when the fogging level may be decreasing or the fogging may have disappeared from the vehicle glass surface (e.g., when the fogging level reduces to 0).

Further vehicle 100 details are described below in conjunction with FIG. 2.

The vehicle 100 implements and/or performs operations, as described here in the present disclosure, in accordance with the owner manual and safety guidelines. In addition, any action taken by the vehicle operator/user based on the notifications/recommendations provided by the vehicle 100 should comply with all the rules specific to the location and operation of the vehicle 100 (e.g., Federal, state, country, city, etc.). The notifications/recommendations, as provided by the vehicle 100, should be treated as suggestions and only followed according to any rules specific to the location and operation of the vehicle 100.

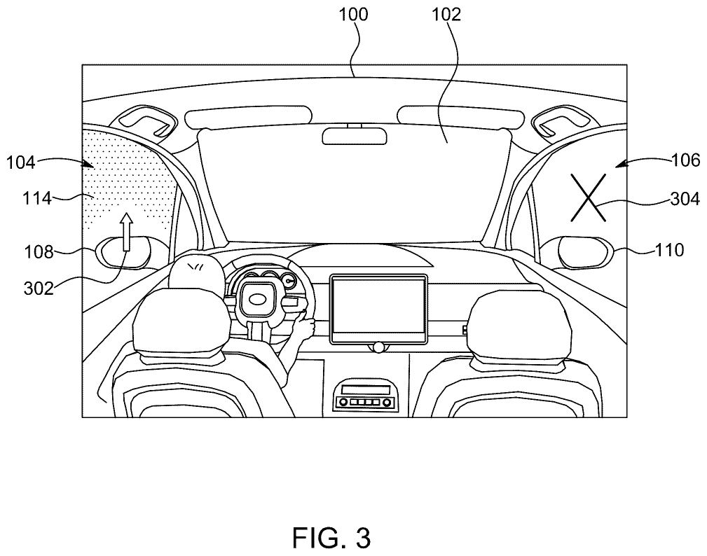

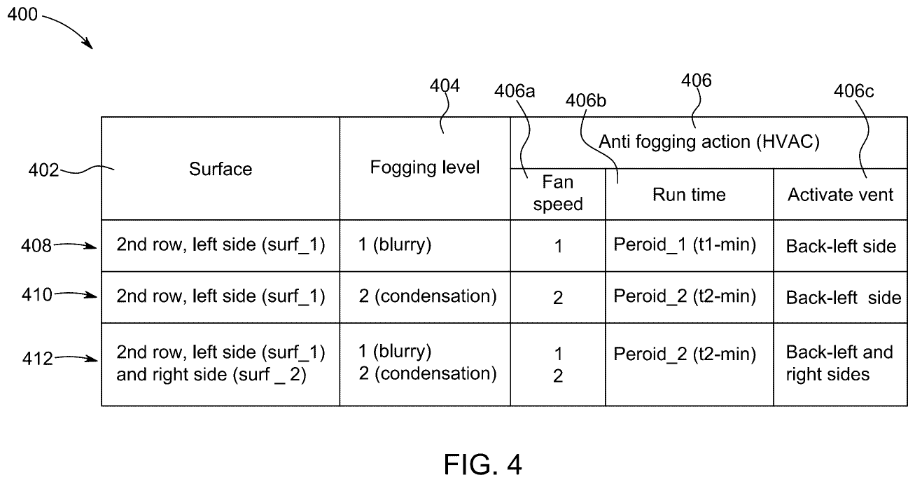

FIG. 2 depicts a block diagram of a system 200 to defog one or more vehicle glass surfaces in accordance with the present disclosure. While describing FIG. 2, references will be made to FIGS. 3 and 4.

The system 200 may include the vehicle 100 and one or more servers 202 (or a server 202) communicatively coupled with each other via one or more networks 204. The server 202 may be part of a cloud-based computing infrastructure and may be associated with and/or include a Telematics Service Delivery Network (SDN) that provides digital data services to the vehicle 100 and other vehicles (not shown in FIG. 2) that may be part of a vehicle fleet.

In further aspects, the server 202 may store the first images and the plurality of second images associated with a plurality of vehicle glass surfaces. As described above in conjunction with FIG. 1, a first image associated with a vehicle glass surface may be an image of the vehicle glass surface with no fogging (or fogging at the level “0”). The second images may be the images of the vehicle glass surface at different fogging levels (e.g., at fogging levels “1”, “2”, “3”, etc.). In additional aspects, the server 202 may be configured to store historical information associated with fogging at each vehicle glass surface. The historical information may include, for example, typical location(s) on each vehicle glass surface from where the fogging begins, historical fogging images associated with each vehicle glass surface, and/or the like. The server 202 may transmit the first image(s), the second images, and the historical information associated with each vehicle glass surface to the vehicle 100 at a predefined frequency, or when the vehicle 100 transmits a request to the server 202 to obtain such information.

The network(s) 204 illustrates an example communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 100 may include a plurality of units including, but not limited to, an HVAC unit 206, an automotive computer 208, a Vehicle Control Unit (VCU) 210, and a fogging control unit 212 (or unit 212). The VCU 210 may include a plurality of Electronic Control Units (ECUs) 214 in communication with the automotive computer 208.

In some aspects, the automotive computer 208 and/or the unit 212 may be installed anywhere in the vehicle 100, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be in communication with one or more memory devices in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing a fogging control program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle 100 systems, connected servers (e.g., the server(s) 202), and other vehicles (not shown in FIG. 2) operating as part of a vehicle fleet. The VCU 210 may include or communicate with any combination of the ECUs 214, such as a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc.

The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a radio detection and ranging (radar) sensor configured for detection and localization of objects inside and outside the vehicle 100 using radio waves, sitting area buckle sensors, sitting area sensors, a light detecting and ranging (lidar) sensor, door sensors, proximity sensors, temperature sensors, wheel sensors, ambient weather sensors, ambient light sensors, vehicle internal and external cameras, one or more rain sensors, a humidity sensor, a tire pressure sensor, ultrasonic sensors, etc.

In some aspects, the humidity sensor (or a “first sensor”) may be configured to detect a humidity level at the front windshield 102. Further, the vehicle cameras, the sitting area buckle sensors, the sitting area sensors, the temperature sensors, the radar sensor(s), etc. (collectively referred to as a “second sensor”) may be configured to detect a presence of users or objects in the vehicle interior portion that may be configured to cause fogging at the plurality of vehicle glass surfaces. As described above, in the present disclosure, the vehicle glass surfaces denote those glass surfaces of the vehicle 100 that are different from the front windshield 102. It is known that when the vehicle glass surface temperature is low/cold, breath of users sitting in proximity to the vehicle glass surface and/or the presence of hot beverages (and/or wet clothes, shoes, etc.) in proximity to the vehicle glass surface may cause fogging at the vehicle glass surface. The second sensor may be configured to detect the presence of users and/or such objects in proximity to the vehicle glass surfaces.

In some aspects, the VCU 210 may control vehicle operational aspects and implement one or more instruction sets received from a user device associated with the user 112, from one or more instruction sets stored in the memory 218, including instructions operational as part of the unit 212.

The TCU 226 may be configured and/or programmed to provide vehicle connectivity to wireless computing systems onboard and off board the vehicle 100 and may include a Navigation (NAV) receiver 234 for receiving and processing a GPS signal, a BLE Module (BLEM) 236, a Wi-Fi transceiver, a UWB transceiver, and/or other wireless transceivers (not shown in FIG. 2) that may be configurable for wireless communication (including cellular communication) between the vehicle 100 and other systems (e.g., the user device, a key fob, an NFC device, etc.), computers, and modules. The NAV receiver 234 may be configured to determine a real-time vehicle geolocation. The TCU 226 may be in communication with the ECUs 214 by way of a bus.

The ECUs 214 may control aspects of vehicle operation and communication using inputs from human drivers, inputs from an autonomous vehicle controller, the unit 212, and/or via wireless signal inputs received via the wireless connection(s) from other connected devices, such as the user device, the server(s) 202, among others.

The BCM 220 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, enclosures, and/or the like. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI) 238). The infotainment system 238 may include a touchscreen interface portion and may include voice recognition features, biometric identification capabilities that can identify users based on facial recognition, voice recognition, fingerprint identification, or other biological identification means. In other aspects, the infotainment system 238 may be further configured to receive user instructions/inputs via the touchscreen interface portion and/or display notifications/recommendations, navigation maps, etc. on the touchscreen interface portion.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 100, may include a transceiver 240, a processor 242, and a computer-readable memory 244.

The transceiver 240 may be configured to receive information/inputs from one or more external devices or systems, e.g., the user device associated with the user 112, the server(s) 202, and/or the like via the network 204. For example, the transceiver 240 may receive the first image(s), the second images, and the historical information associated with each vehicle glass surface from the server 202 via the network 204. Further, the transceiver 240 may transmit notifications (e.g., alert/alarm signals) to the external devices or systems. In addition, the transceiver 240 may be configured to receive information/inputs from vehicle 100 components such as the infotainment system 238, the vehicle sensory system 232, the TCU 226, and/or the like. Further, the transceiver 240 may transmit notifications (e.g., alert/alarm/command signals) to the vehicle 100 components such as the infotainment system 238, the BCM 220, the HVAC unit 206, etc.

The processor 242 and the memory 244 may be the same as or similar to the processor 216 and the memory 218, respectively. In some aspects, the processor 242 may utilize the memory 244 to store programs in code and/or to store data for performing aspects in accordance with the disclosure. The memory 244 may be a non-transitory computer-readable medium or memory storing the fogging control program code. In some aspects, the memory 244 may be configured to store the first image(s), the second images, and the historical information associated with each vehicle glass surface that the vehicle 100 obtains from the server 202.

In operation, in one exemplary aspect, the processor 242 may obtain inputs from the second sensor described above, and determine a probability of fogging at each vehicle glass surface, of the plurality of vehicle glass surfaces, based on the inputs obtained from the second sensor. As an example, the processor 242 may determine the probability of fogging at each vehicle glass surface based on whether a user (e.g., the user 112 or any other occupant) is sitting in proximity to the vehicle glass surface or any object that may cause fogging is present in proximity to the vehicle glass surface, based on the inputs obtained from the second sensor. Responsive to determining the probability at each vehicle glass surface, the processor 242 may compare the probabilities with a first predefined threshold (e.g., 50 or 60%).

The processor 242 may identify one or more “target” vehicle glass surfaces to focus on (or to spend processing resources on to detect fogging) based on the comparison described above. In some aspects, the target vehicle glass surface may have the associated probability greater than the first predefined threshold. As an example, as shown in FIG. 1, since the user 112 is sitting in proximity to the left side window 104, the processor 242 may determine that the probability of fogging may be greater than the first predefined threshold at the left side window 104. In this case, the processor 242 may identify the left side window 104 as the target vehicle glass surface.

Responsive to identifying the target vehicle glass surface (e.g., the left side window 104), the processor 242 may obtain inputs from the first sensor (e.g., the humidity sensor), and check whether the humidity level at the front windshield 102 is greater than a second predefined threshold based on the inputs obtained from the first sensor. Responsive to determining that the humidity level at the front windshield 102 is greater than the second predefined threshold, the processor 242 may commence the process of detecting the presence of fogging at the identified target vehicle glass surface.

Since the processor 242 commences the process of detecting the presence of fogging at the identified target vehicle glass surface, and not on all the vehicle glass surfaces, the processor 242 saves resources required to identify the presence of fogging at all vehicle glass surfaces. A person ordinarily skilled in the art may appreciate that considerable processor resources may get utilized if the processor 242 attempts to detect the presence of fogging on all vehicle glass surfaces. By focusing the process of detection on those vehicle glass surfaces that have high probability of getting fogged (i.e., the target vehicle glass surface(s)), the processor 242 is able to save resources required for processing. Furthermore, by focusing the process of detection on the target vehicle glass surface(s), the processor 242 is able to save time required to detect the presence of fogging.

In alternative aspects, the processor 242 may skip the step of identifying the target vehicle glass surface described above, and may commence the process of detecting the presence of fogging at all vehicle glass surfaces, without departing from present disclosure scope. Stated another way, the step of identifying the target vehicle glass surface is not necessary for the implementation of the present disclosure. The description below is described in context of the aspect where the processor 242 performs the step of identifying the target vehicle glass surface before commencing the process of detecting the presence of fogging; however, such description should not be construed as limiting.

In some aspects, the processor 242 may commence the process of detecting the presence of fogging at the target vehicle glass surface by obtaining image(s) of the target vehicle glass surface and then analyzing the obtained image(s), as described below. In other aspects, if the processor 242 is already obtaining the image(s) of the target vehicle glass surface (even before the time when the humidity level at the front windshield 102 becomes greater than the second predefined threshold), the processor 242 may commence the process of detecting the presence of fogging at the target vehicle glass surface by increasing a rate (or frequency) of obtaining the target vehicle glass surface images and analyzing them.

The process of detecting the presence of fogging at the target vehicle glass surface is described below.

In some aspects, responsive to identifying the target vehicle glass surface (e.g., the left side window 104) and determining that the humidity level at the front windshield 102 is greater than the second predefined threshold, the processor 242 may obtain the left side window image from a vehicle camera that may be configured to capture the left side window image. Stated another way, the processor 242 may obtain the left side window image from a vehicle camera that may have the left side window 104 in its field of view (FOV).

The processor 242 may then compare the obtained left side window image with the first image associated with the left side window 104 (i.e., the pre-stored image of the left side window 104 with no fogging) to detect the presence of fogging at the left side window 104. Specifically, the processor 242 may detect the presence of fogging at the left side window 104 when the obtained left side window image may be different from the first image associated with the left side window 104.

In some aspects, the first image associated with the left side window 104 may include multiple images at different ambient conditions/light intensities (e.g., at low light, at bright light, at night time, at day time, etc.). Based on a real-time ambient condition in the vehicle interior portion (determined based on inputs obtained from the vehicle sensory system 232), the processor 242 may select and compare an appropriate first image with the obtained left side window image to detect the presence of fogging at the left side window 104. In this manner, the processor 242 may be able to detect the presence of fogging at the left side window 104 at different ambient conditions or light intensities. In an exemplary aspect, if the vehicle cameras include thermal detection capability, the processor 242 may compare the images based on image heat map analysis.

In some aspects, the first images associated with different vehicle glass surfaces may also be different based on the location of the vehicle glass surfaces in the vehicle 100 and/or a type of the vehicle glass surfaces (e.g., if the glasses are tinted or not tinted). For example, the first image associated with the rear windshield may be different from the first image associated with the left rearview mirror 108, as the locations and types of these glass surfaces are different. The processor 242 may compare the target vehicle glass surface image with its respective first image to accurately detect the presence of fogging, based on the target vehicle glass surface location and/or type.

In further aspects, to enhance or quicken the process of detecting the presence of fogging at the target vehicle glass surface (e.g., the left side window 104), the processor 242 may first identify an expected or typical fogging start location at the left side window 104 (at which the fogging typically starts at the left side window 104) based on the historical information/fogging images associated with the left side window 104 and/or the inputs obtained from the second sensor. Responsive to identifying the expected fogging start location, the processor 242 may start to analyze or compare the portion of the left side window image that corresponds to the expected fogging start location with the corresponding portion in the first image, to quickly detect the presence of fogging at the left side window 104. Since the typical or expected fogging start location may be a small portion within the left side window 104 where the probability of fogging commencement may be high, the processor 242 is able to quickly detect the presence of fogging at the left side window 104 by utilizing minimal processing resources by focusing on this “small portion” of the glass surface in the left side window image.

Responsive to comparing the obtained left side window image with the first image and determining that the obtained left side window image is different from the first image, the processor 242 may determine the presence on fogging on the left side window 104 (as shown in FIG. 1). Responsive to detecting the presence on fogging on the left side window 104, the processor 242 may determine a fogging level at the left side window 104 based on the obtained left side window image.

In some aspects, the processor 242 may be an Artificial Intelligence (AI) based processor that may be configured to use a training data (that may include the first and second images associated with each vehicle glass surface) stored in the memory 244 to compare and correlate the obtained left side window image with the associated second images to determine a “match” between the obtained left side window image and one second image associated with the left side window 104. Specifically, responsive to detecting the presence of fogging on the left side window 104, the processor 242 may correlate the obtained left side window image with the second images associated with the left side window 104 to determine a second image that substantially matches with the obtained left side window image. Since the second images are associated with different fogging levels (as described above in conjunction with FIG. 1), the processor 242 may determine a fogging level at the left side window 104 based on the correlation described above (i.e., based on the second image that “matches” with the obtained left side window image). For example, the processor 242 may determine that the fogging level at the left side window 104 may be “1” when the obtained left side window image matches with the second image associated with the fogging level “1”, the fogging level at the left side window 104 may be “2” when the obtained left side window image matches with the second image associated with the fogging level “2”, and so on.

Responsive to determining the fogging level at the left side window 104, the processor 242 may control an HVAC unit operation based on the fogging level to defog the left side window 104. Specifically, in this case, the processor 242 may control the HVAC unit vents such that the HVAC unit 206 blows air towards the left side window 104, which may defog the left side window 104 (as shown by an arrow 302 in FIG. 3).

In some aspects, the processor 242 may cause the HVAC unit 206 to blow air only towards those vehicle glass surfaces that may be fogged and not towards all the vehicle glass surfaces, thereby conserving energy required to operate the HVAC unit 206. For example, as shown in FIG. 3, since the fogging is present only on the left side window 104 and not on the right side window 106, the processor 242 may cause the HVAC unit 206 to blow air only towards the left side window 104 (as shown by the arrow 302) and not towards the right side window 106 (as shown by a cross sign 304).

The processor 242 may be further configured to control/adjust an HVAC airflow rate (e.g., fan speed) towards the target vehicle glass surface and/or a time duration for which the HVAC unit 206 may blow air towards the target vehicle glass surface based on the determined fogging level and/or a target vehicle glass surface location in the vehicle 100. The HVAC airflow rate and/or the time duration may also be adjusted/based on a target vehicle glass surface type (e.g., if the glasses are tinted or not tinted).

An example table 400 illustrating one or more mitigation actions that may be performed by the processor 242 to defog one or more vehicle glass surfaces is shown in FIG. 4. In the table 400, a column 402 depicts the vehicle glass surface(s) at which the processor 242 may have detected the presence of fogging, a column 404 depicts a fogging level at the vehicle glass surface(s), and a column 406 depicts an anti-fogging action (HVAC) performed by the processor 242 (e.g., controlling an HVAC unit fan speed 406a, an HVAC unit run time 406b, and activating or controlling HVAC vents 406c).

As shown in a row 408, when the surface on which the fogging is detected is at a vehicle second row and on the left side (e.g., a left side rear window, or “surf_1”), and the fogging level may be “1” (indicating blurry surface), the processor 242 may set the HVAC fan speed to a first speed or “1”, have the HVAC unit 206 blow air towards “surf_1” for a first predefined time duration (e.g., “Period_1 (t1-min)”), and activate a back left side vent of the HVAC unit 206.

Similarly, as shown in a row 410, when the surface on which the fogging is detected is “surf_1”, and the fogging level may be “2” (indicating condensation), the processor 242 may set the HVAC fan speed to a second speed or “2”, have the HVAC unit 206 blow air towards “surf 1” for a second predefined time duration (e.g., “Period_2 (t2-min)”), and activate the back left side HVAC vent.

Further, as shown in a row 412, when “surf_1” has a fogging level of “1”, and simultaneously a window at the right side (e.g., a right side rear window, or “surf_2”) has a fogging level of “2”, the processor 242 may set the HVAC fan speed to “1” for “surf_1” and the HVAC fan speed to “2” for “surf_2”, have the HVAC unit 206 blow air towards both the “surf_1” and “surf_2” for the second predefined time duration, and activate both the back right and left side HVAC vents.

In additional aspects, the processor 242 may be configured to monitor a rate of change in the fogging level on the target vehicle glass surface/left side window 104 (as used in the example described above) over time based on a correlation between real-time left side window images and the second images associated with the left side window 104. For example, based on the correlation of these images, the processor 242 may determine whether the fogging level is increasing or decreasing with time. The processor 242 may further adjust the HVAC unit operation based on the rate of change in the fogging level. As an example, the processor 242 may reduce the HVAC fan speed and/or the time duration of HVAC unit operation if the fogging level is decreasing over time, to conserve resources/energy required to operate the HVAC unit 206. The processor 242 may further disable the HVAC unit 206 from blowing air towards the target vehicle glass surface when the processor 242 determines that the fogging level at the target vehicle glass surface may have become equivalent to the level “0”.

In additional aspects of the present disclosure, if the processor 242 determines that multiple vehicle glass surfaces may be experiencing fogging, the processor 242 may activate the HVAC unit 206 for the entire vehicle interior portion/cabin to defog all the affected vehicle glass surfaces at once. In this case, the processor 242 may additionally output a notification, via the infotainment system 238, requesting the user 112 to open a small vent in the vehicle 100 to let fresh/ambient air into the vehicle interior portion/cabin, and hence defog the affected vehicle glass surfaces. The processor 242 may additionally request the user 112 to check if any vehicle occupant may be smoking, and request the smoking occupant to stop or temporarily move out of the vehicle 100, to facilitate defogging of the affected vehicle glass surfaces.

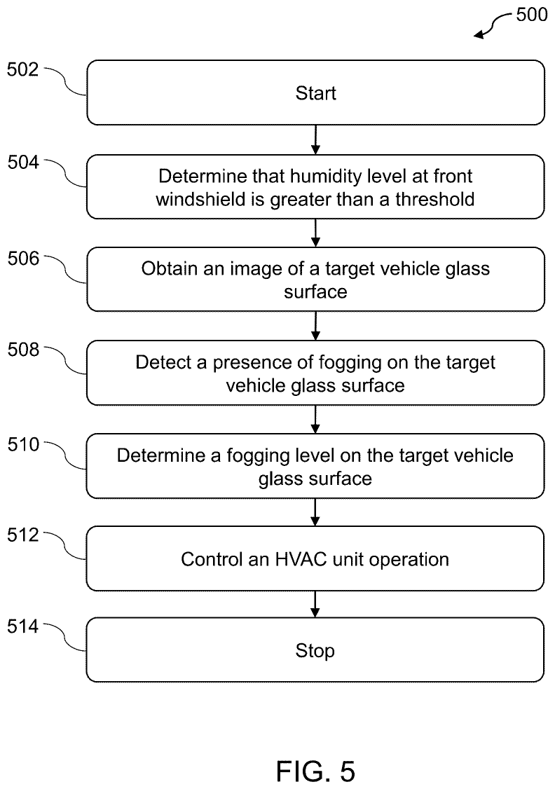

FIG. 5 depicts a flow diagram of an example method 500 to defog one or more vehicle glass surfaces in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include determining, by the processor 242, that the humidity level at the front windshield 102 is greater than a predefined threshold based on the inputs obtained from the first sensor/humidity sensor. At step 506, the method 500 may include obtaining, by the processor 242, a target vehicle glass surface image responsive to determining that the humidity level is greater than the predefined threshold.

At step 508, the method 500 may include detecting, by the processor 242, a presence of fogging on the target vehicle glass surface based on the image. At step 510, the method 500 may include determining, by the processor 242, a fogging level on the target vehicle glass surface based on the image, responsive to detecting the presence of fogging. At step 512, the method 500 may include controlling, by the processor 242, the HVAC unit operation based on the fogging level to defog the target vehicle glass surface, as described above.

At step 514, the method 500 may end.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a front windshield;
a first sensor configured to detect a humidity level at the front windshield;
a camera configured to capture an image of a target vehicle glass surface;
a heating, ventilation, and air conditioning (HVAC) unit; and
a processor configured to:
determine that the humidity level is greater than a first predefined threshold based on inputs obtained from the first sensor;
obtain the image from the camera responsive to determining that the humidity level is greater than the first predefined threshold;
detect a presence of fogging on the target vehicle glass surface based on the image;
determine a fogging level on the target vehicle glass surface based on the image, responsive to detecting the presence of fogging; and
control an HVAC unit operation based on the fogging level to defog the target vehicle glass surface.

2. The vehicle of claim 1, wherein the target vehicle glass surface is different from the front windshield.

3. The vehicle of claim 1 further comprising a second sensor configured to detect a presence of users or objects that are configured to cause fogging at a plurality of vehicle glass surfaces, wherein the processor is further configured to:
obtain inputs from the second sensor;
determine a probability of fogging at multiple vehicle glass surfaces of the plurality of vehicle glass surfaces, based on the inputs obtained from the second sensor; and
identify the target vehicle glass surface from the multiple of vehicle glass surfaces based on the probability, wherein the probability associated with the target vehicle glass surface is greater than a second predefined threshold.

4. The vehicle of claim 3, wherein the processor is further configured to:
identify an expected fogging start location at the target vehicle glass surface based on at least one of the inputs obtained from the second sensor and historical fogging images associated with the target vehicle glass surface; and
analyze the image associated with the expected fogging start location at the target vehicle glass surface to detect the presence of fogging on the target vehicle glass surface.

5. The vehicle of claim 1 further comprising a memory configured to store a first image associated with the target vehicle glass surface with no fogging and a plurality of second images associated with the target vehicle glass surface with different fogging levels, wherein the processor is configured to:
compare the image obtained from the camera with the first image; and
detect the presence of fogging on the target vehicle glass surface when the image obtained from the camera is different from the first image.

6. The vehicle of claim 5, wherein the processor is further configured to:
correlate the image obtained from the camera with the plurality of second images, responsive to detecting the presence of fogging on the target vehicle glass surface; and
determine the fogging level on the target vehicle glass surface based on the correlation.

7. The vehicle of claim 6, wherein the processor is further configured to:
monitor a rate of change in the fogging level on the target vehicle glass surface over time based on the correlation; and
adjust the HVAC unit operation based on the rate of change in the fogging level.

8. The vehicle of claim 1, wherein, to control the HVAC unit operation based on the fogging level at the target vehicle glass surface, the processor is configured to cause the HVAC unit to blow air towards the target vehicle glass surface.

9. The vehicle of claim 8, wherein the processor is further configured to adjust at least one of an HVAC airflow rate towards the target vehicle glass surface or a time duration to blow air towards the target vehicle glass surface based on the fogging level.

10. The vehicle of claim 9, wherein the processor is further configured to adjust at least one of the HVAC airflow rate or the time duration based on a target vehicle glass surface location.

11. The vehicle of claim 1, wherein the processor is further configured to detect the presence of fogging on the target vehicle glass surface based on at least one of: a target vehicle glass surface location, a target vehicle glass surface type, or an ambient light level.

12. A method comprising:
determining, by a processor, that a humidity level at a front windshield of a vehicle is greater than a first predefined threshold based on inputs obtained from a first sensor;
obtaining, by the processor, an image of a target vehicle glass surface from a camera responsive to determining that the humidity level is greater than the first predefined threshold;
detecting, by the processor, a presence of fogging on the target vehicle glass surface based on the image;
determining, by the processor, a fogging level on the target vehicle glass surface based on the image, responsive to detecting the presence of fogging; and
controlling, by the processor, a heating, ventilation, and air conditioning (HVAC) unit operation based on the fogging level to defog the target vehicle glass surface.

13. The method of claim 12, wherein the target vehicle glass surface is different from the front windshield.

14. The method of claim 12 further comprising:
obtaining inputs from a second sensor configured to detect a presence of users or objects that are configured to cause fogging at a plurality of vehicle glass surfaces;
determining a probability of fogging at each vehicle glass surface, from the plurality of vehicle glass surfaces, based on the inputs obtained from the second sensor; and
identifying the target vehicle glass surface from the plurality of vehicle glass surfaces based on the probability, wherein the probability associated with the target vehicle glass surface is greater than a second predefined threshold.

15. The method of claim 14 further comprising:
identifying an expected fogging start location at the target vehicle glass surface based on at least one of the inputs obtained from the second sensor and historical fogging images associated with the target vehicle glass surface; and
analyzing the image associated with the expected fogging start location at the target vehicle glass surface to detect the presence of fogging on the target vehicle glass surface.

16. The method of claim 12, wherein controlling the HVAC unit operation comprises causing the HVAC unit to blow air towards the target vehicle glass surface.

17. The method of claim 16, wherein controlling the HVAC unit operation further comprises adjusting at least one of an HVAC airflow rate towards the target vehicle glass surface or a time duration to blow air towards the target vehicle glass surface based on the fogging level.

18. The method of claim 17 further comprising adjusting at least one of the HVAC airflow rate or the time duration based on a target vehicle glass surface location.

19. The method of claim 12 further comprising:
comparing the image obtained from the camera with a first image, wherein the first image is associated with the target vehicle glass surface with no fogging;
detecting the presence of fogging on the target vehicle glass surface when the image obtained from the camera is different from the first image;
correlating the image obtained from the camera with a plurality of second images responsive to detecting the presence of fogging on the target vehicle glass surface, wherein the plurality of second images is associated with the target vehicle glass surface with different fogging levels; and
determining the fogging level on the target vehicle glass surface based on the correlation.

20. A non-transitory computer-readable storage medium having instructions stored thereupon which, when executed by a processor, cause the processor to:
determine that a humidity level at a front windshield of a vehicle is greater than a predefined threshold based on inputs obtained from a sensor;
obtain an image of a target vehicle glass surface from a camera responsive to determining that the humidity level is greater than the predefined threshold;
detect a presence of fogging on the target vehicle glass surface based on the image;
determine a fogging level on the target vehicle glass surface based on the image, responsive to detecting the presence of fogging; and
control a heating, ventilation, and air conditioning (HVAC) unit operation based on the fogging level to defog the target vehicle glass surface.
